(19) United States
(12) Patent Application Publication
(10) Pub. No.: US 2016/0368156 A1
(43) Pub. Date: Dec. 22, 2016

(54) Scissors and Manufacturing Method Therefor

(71) Applicant: Acme United Corporation, Fairfield, CT (US)

(72) Inventors: Sarah A. Albano, Fairfield, CT (US); Siu-Leung Tang, Hong Kong (CN)

(21) Appl. No.: 14/740,922

(22) Filed: Jun. 16, 2015

(51) Int. Cl. B26B 13/20; B26B 13/28

(52) U.S. Cl. CPC B26B 13/20; B26B 13/28

(57) ABSTRACT

A pair of scissors comprises a pair of molded handle components which receive a blade and are joined at a pivot. One of the components has a thumb bow which forms a thumb opening and also defines a transition opening between the thumb opening and the pivot. The second component comprises a finger bow which forms a finger opening and also defines a transition opening between the finger bow and the pivot. The molded components are manufactured by injecting ABS or other molded material through an injection gate which is adjacent a reduced neck portion and a connecting strut which integrally connects the neck portion with the bow portion and partially defines a transition opening.

### BACKGROUND

This disclosure relates generally to scissors and methods of manufacturing same. More particularly, this disclosure relates to scissors employing molded handle components.

In scissors and manufacturing methods to which the present disclosure relates, it is common to provide molded thumb bow and finger bow handle components. Each of the handle components fixedly receives a metal scissor blade. The handle/blade assemblies are pivotally joined to form a pair of cooperative scissors.

### SUMMARY

Briefly stated, the scissors in a preferred form comprises a first scissor component comprises a first blade and a first handle connecting the first blade and having a first pivot and a thumb bow defining a thumb opening and a first transition opening disposed between said first pivot and said thumb opening. A second scissor component comprises a second blade and a second handle connecting the second blade and having a second pivot and a finger bow defining a finger opening and a second transition opening disposed between said second pivot and said finger opening. The first and second scissor components are pivotally joined at the first and second pivots.

The first scissor component comprises a reduced neck portion and a pair of struts connecting the reduced neck portion with the thumb bow. The second scissor component also comprises a reduced neck portion and a pair of struts connecting the reduced neck portion to the finger bow. The first transition opening has a quasi-triangular shape. The second transition opening also has a quasi-triangular shape. The first handle and the second handle are molded components. The molded components are preferably formed from ABS material.

The first scissor component and the second scissor component, in a pivotally closed position, define an effective surface profile projection wherein the first and second transition openings and thumb and finger openings having an area greater than 30% of the effective surface profile projection of the first handle and the second handle. The struts generally diverge at an acute angle from the reduced neck portion.

A method for manufacturing a scissor handle component comprises providing a mold configured to form a thumb bow defining a thumb opening and an opposite pivot portion. The pivot portion transitions to a reduced neck portion and is configured to form a transition opening between the neck portion and the thumb bow. The method comprises injecting molding material into the mold at a location adjacent an intersection between the reduced neck portion and the structure at least partially defining the transition opening, to form a handle component.

In one embodiment, the method further comprises providing a second mold configured to form a finger bow defining a finger opening and an opposite pivot portion. The pivot portion transitions to a reduced neck portion and is configured to form a second transition opening between the reduced neck portion and the finger bow. The method further comprises injecting molding material into the second mold at a location adjacent an intersection between the reduced neck portion and the structure at least partially defining the second transition opening, to form a second handle component. The molding material is preferably ABS material.

A pair of scissors, in one embodiment, comprises a first scissor component comprising a first blade and a molded first handle connecting the first scissor and having a first pivot and a thumb bow defining a thumb opening and a quasi-triangular first transition opening disposed between the first pivot and the thumb opening. The first transition opening is at least partially defined by a first pair of first struts integrally connecting the thumb bow. A second scissor component comprises a second blade and a second handle connecting the blade portion and having a second pivot and a finger bow defining a finger opening and a second quasi-triangular transition opening between the second pivot and the finger opening. The second transition opening is at least partially defined by a second pair of struts integrally connecting the finger bow. The first and second scissor components are pivotally joined at the first and second pivots.

The first scissor component comprises a reduced neck portion and the first pair of struts integrally connects the reduced neck portion with the thumb bow. The second scissor component comprises a second reduced neck portion and the second pair of struts integrally connects the second reduced neck portion to the finger bow. The molded handles are formed from ABS material.

The first scissor component and the second scissor component, in a pivotally closed position, defines an effective surface profile projection wherein the first and second transition openings and the thumb and finger openings have an area greater than 30% of the effective surface profile projection of the first handle and the second handle. The first pair of struts generally diverges at an acute angle from the reduced neck portion. The second pair of struts also generally diverges at an acute angle from the second reduced neck portion.

### BRIEF DESCRIPTION OF THE DRAWINGS

FIG. 1 is a front view of a representative pair of scissors;

FIG. 2 is an opposite diagrammatic rear side view of the scissors of FIG. 1;

FIG. 3 is a right side diagrammatic view of the scissors of FIG. 1;

FIG. 4 is a frontal handle surface profile projection of the scissors of FIG. 1;

FIG. 5 is a frontal handle surface profile projection, without openings, for the handles of FIG. 1;

FIG. 6 is a schematic stress distribution diagram, partly annotated, for the thumb bow handle component of the scissors of FIG. 1;

FIG. 7 is a schematic diagrammatic view illustrating a representative test force distribution for the thumb bow handle component of FIG. 6;

FIG. 8 is a schematic diagrammatic view illustrating the representative test force for a corresponding finger bow handle component of FIG. 7 without a transition opening; and

FIG. 9 is a schematic annotated diagrammatic view of a thumb bow handle component of the scissors of FIG. 1 further illustrating a preferred injection gate location for manufacturing the molded handle component.

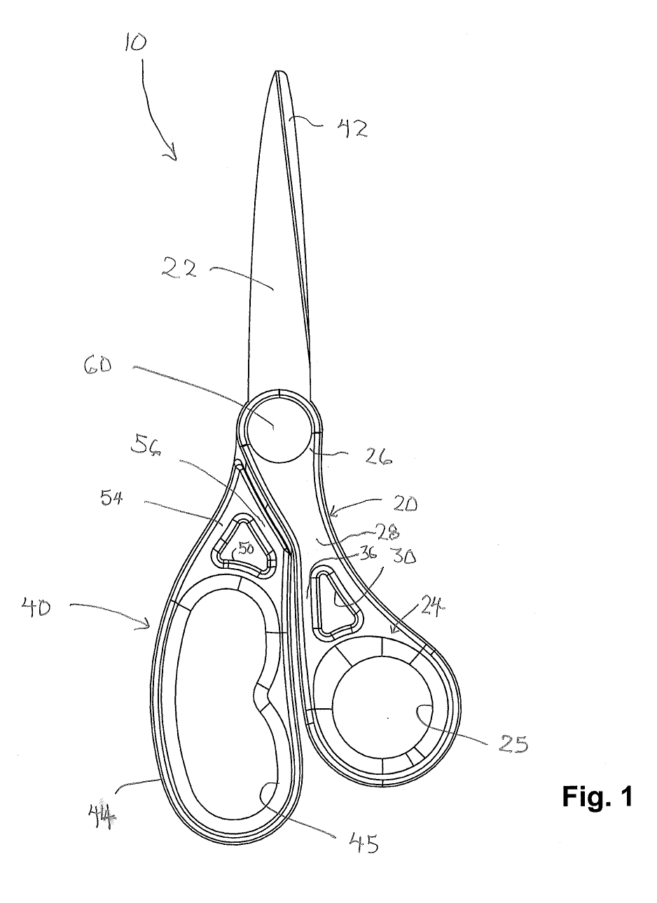

### DETAILED DESCRIPTION

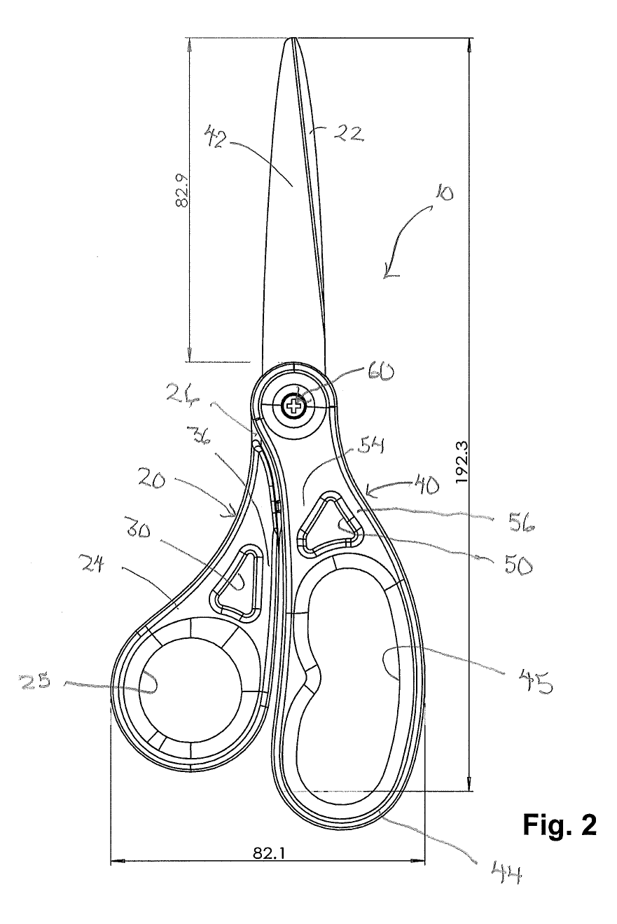

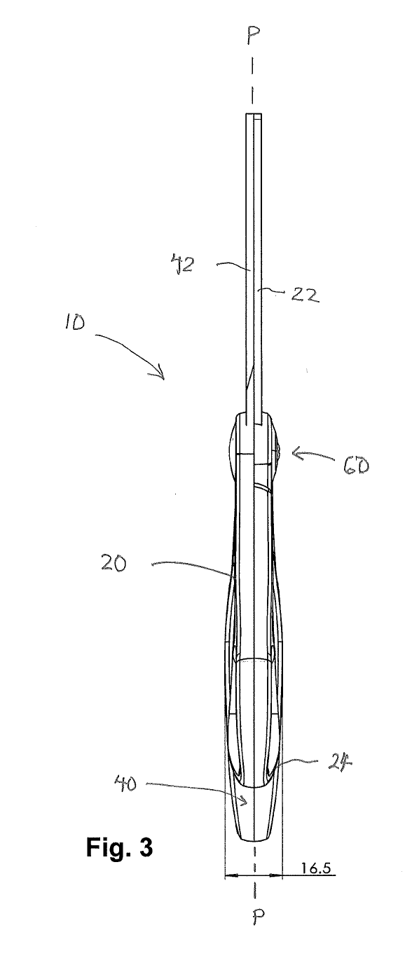

With reference to the drawings wherein like numerals represent like parts throughout the figures, a representative pair of scissors is designated generally by the numeral 10. Scissors 10 has an efficient structure with a minimalized construction which does not adversely affect the structural and functional integrity of the scissors. Dimensions in millimeters for one preferred 8 inch embodiment are illustrated in FIGS. 2 and 3. Scissors 10 may be provided in numerous sizes and dimensions and have numerous contour variations, blade configurations and exterior surface color schemes.

Scissors 10 includes a thumb handle component 20 which receives a steel or composite metal scissor 22 and a finger component 40 which receives a steel or composite metal scissor 42. The scissors 22 and 42 are staked, captured or otherwise fixedly connected with the respective handle components 20 and 40 and are joined at a pivot 60 to form the pair of scissors. The pivot 60 can assume numerous forms. The handle components 20 and 40 are molded components.

Handle component 20 includes a thumb bow 24 which preferably has a contoured circular or quasi-circular thumb opening 25. The opposing end portion of the handle includes an enlarged pivot support 26 which intermediately tapers to a reduced neck 28. A quasi-triangular shaped transition opening 30 is formed between the thumb bow opening 25 and the pivot support 26. The transition opening 30 is partially defined by a pair of struts 34 and 36 which integrally connect with the neck 28 and angularly diverge to integrally connect with the thumb bow 24 surrounding and defining the thumb opening 25.

The finger handle component 40 includes a finger bow 44 which defines a contoured finger opening 45 and an enlarged opposite pivot support 46 which intermediately tapers to a neck portion 48. A quasi-triangular shaped transition opening 50 is formed between the finger opening 45 and the pivot support 46. Angularly oriented struts 54 and 56 integrally connect the neck 48 to the finger bow 44.

The handle components 20 and 40 are preferably molded from ABS (acrylonitrile butatiene styrene) material. Other plastic and molding compositions are possible. Because of the transition openings 30 and 50, less material is required than were the handle portions otherwise solid throughout except for the thumb and finger openings. However, structural integrity of the handle portions is ensured by both the handle configurations and the method of injection molding.

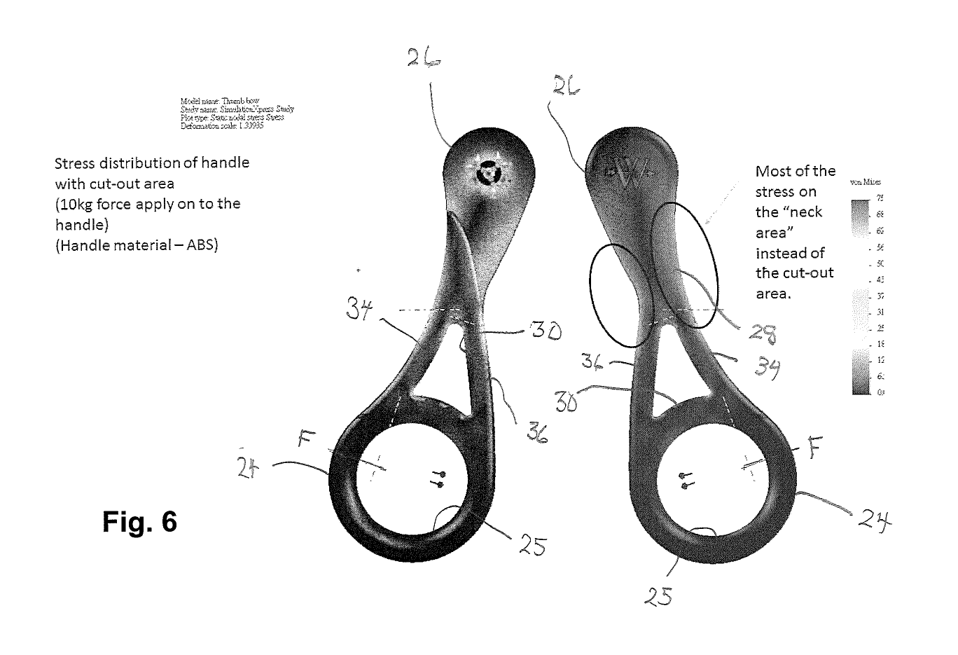

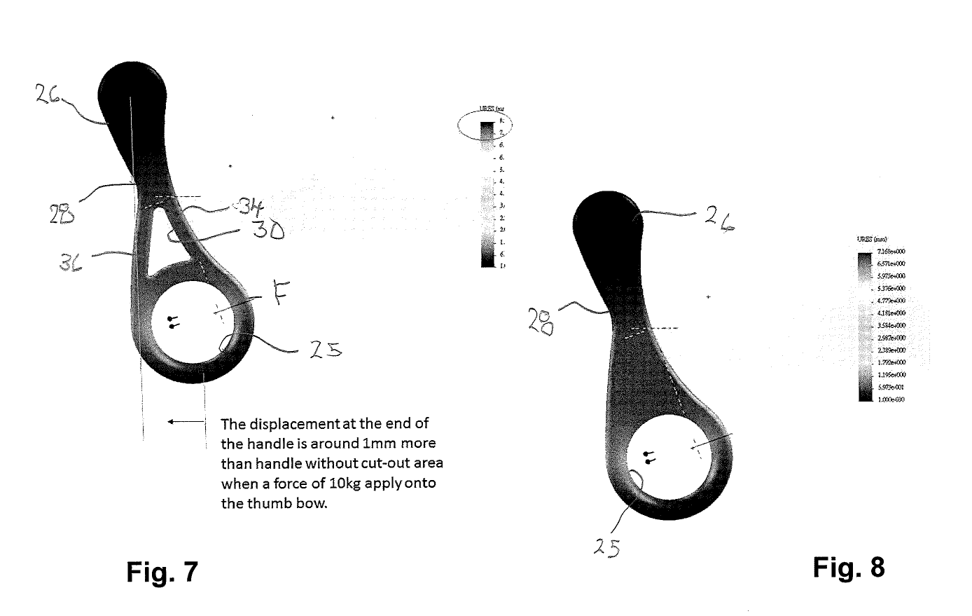

Upon assembly and normal usage of the scissors, the handle components are configured so that most of the stress is applied to the neck portions 28 and 48. FIGS. 6 and 7 illustrate the stress distribution on the handle component 20. During normal usage, most of the stress is applied to the neck area as opposed to the struts 34, 36 and 54, 56. For example, when a 10 kg test force F is applied to the handle component 20 as illustrated in comparison to a similar handle which does not include the transition opening (such as illustrated in FIG. 8), the displacement at the end of the handle component is approximately 1 mm more than without the cutout region of the transition opening 30. The limited displacement is sufficiently constraining to provide a suitable structural and functional integrity for the handle component. A similar force application characteristic is also found with respect to handle component 40.

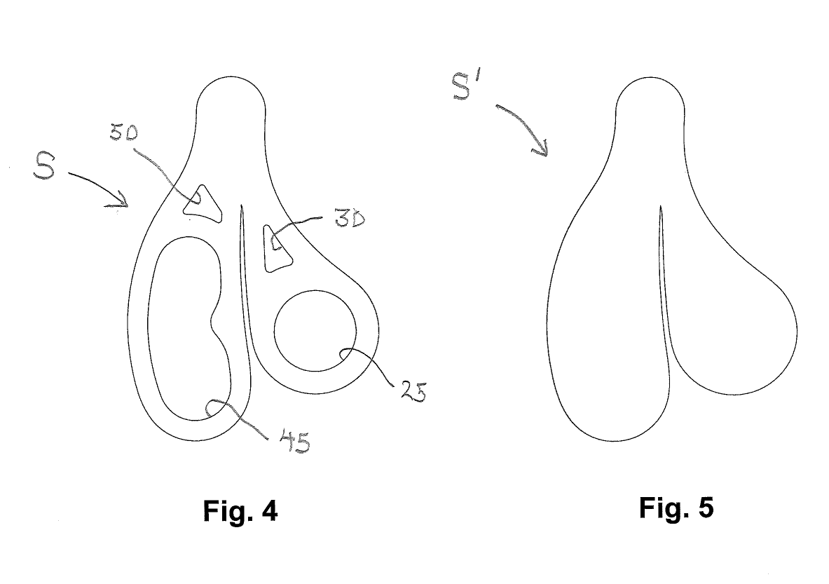

FIGS. 4 and 5 illustrate the relationship between the handle components without any openings whatsoever (FIG. 5) and with the openings (FIG. 4) including the transition openings for the pair of cooperative handle components. For comparison purposes, a central plane P (See FIG. 2) through the scissors in the pivotally closed position forms an effective surface profile projection S when viewed from the front. In the illustrated embodiment, the surface profile projection area is approximately 36% less than that of the surface profile projection S′ area without any openings, such as illustrated in FIG. 5.

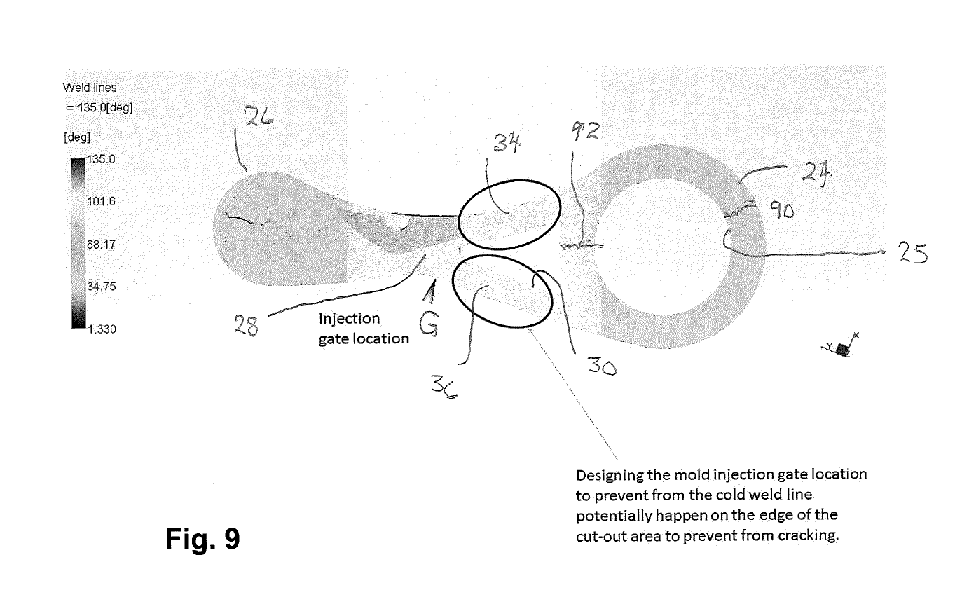

An important manufacturing key to forming the handle components is the injection gate location for the handles. As best illustrated in FIG. 9, the injection gate location G for molded component 20 is close to the transition from the reduced neck portion 28 to the struts 36 and 34. A similar preferred injection gate location would be applicable to handle component 40. The noted gate location prevents a potential cold weld line on the edge of the cutout area to prevent cracking of the components, such as hypothetically illustrated by numerals 90 and 92.

While preferred embodiments of the foregoing scissors and manufacturing method have been set forth for purposes of illustration, the foregoing should not be deemed a limitation of the invention herein. Accordingly, various modifications, adaptations and alternatives may occur to one skilled in the art without departing from the spirit and the scope of the present invention.

1. A pair of scissors comprising:
a first scissor component comprising a first blade and a first handle connecting said first blade and having a first pivot and a thumb bow defining a thumb opening and a first transition opening disposed between said first pivot and said thumb opening; and
a second scissor component comprising a second blade and a second handle connecting said second blade and having a second pivot and a finger bow defining a finger opening and a second transition opening between said second pivot and said finger opening,
wherein said first and second scissor components are pivotally joined at said first and second pivots.

2. The scissors of claim 1 wherein said first scissor component comprises a reduced neck portion and a pair of struts connecting said reduced neck portion with said thumb bow.

3. The scissors of claim 1 wherein said second scissor component comprises a reduced neck portion and a pair of struts connecting said reduced neck portion to said finger bow.

4. The scissors of claim 1 wherein said first transition opening has a quasi-triangular shape.

5. The scissors of claim 1 wherein said second transition opening has a quasi-triangular shape.

6. The scissors of claim 1 wherein said first handle and said second handle are molded components.

7. The scissors of claim 6 wherein said molded components are formed from ABS material.

8. The scissors of claim 1 wherein said first scissor component and said second scissor component in a pivotally closed position define an effective surface profile projection wherein said first and second transition openings and thumb and finger openings have an area greater than 30% of the effective surface profile projection of said first handle and said second handle.

9. The scissors of claim 2 wherein said struts generally diverge at an acute angle from said reduced neck portion.

10. A method for manufacturing a scissor handle component comprising:
providing a mold configured to form a thumb bow defining a thumb opening and an opposite pivot portion, said pivot portion transitioning to a reduced neck portion and configured to form a transition opening between said neck portion and said thumb bow; and
injecting molding material into said mold at a location adjacent an intersection between said reduced neck portion and structure at least partially defining said transition opening to form a handle component.

11. The method of claim 10 further comprising:
providing a second mold configured to form a finger bow defining a finger opening and an opposite pivot portion, said pivot portion transitioning to a reduced neck portion and configured to form a second transition opening between said reduced neck portion and said finger bow; and
injecting molding material into said second mold at a location adjacent an intersection between said reduced neck portion and structure at least partially defining said second transition opening to form a second handle component.

12. The method of claim 10 wherein said molding material is ABS material.

13. The method of claim 11 wherein said molding material is ABS material.

14. A pair of scissors comprising:
a first scissor component comprising a first blade and a molded first handle connecting said first scissor and having a first pivot and a thumb bow defining a thumb opening and a quasi-triangular first transition opening disposed between said first pivot and said thumb opening, said first transition opening at least partially defined by a first pair of first struts integrally connecting said thumb bow; and
a second scissor component comprising a second blade and a second handle connecting said second blade and having a second pivot and a finger bow defining a finger opening and a second quasi-triangular transition opening between said second pivot and said finger opening, said second transition opening at least partially defined by a second pair of first struts integrally connecting said finger bow,
wherein said first and second scissor components are pivotally joined at said first and second pivots.

15. The scissors of claim 14 wherein said first scissor component comprises a reduced neck portion and said first pair of struts integrally connect said reduced neck portion with said thumb bow.

16. The scissors of claim 14 wherein said second scissor component comprises a second reduced neck portion and said second pair of struts integrally connect said second reduced neck portion to said finger bow.

17. The scissors of claim 14 wherein said molded handles are formed from ABS material.

18. The scissors of claim 14 wherein said first scissor component and said second scissor component in a pivotally closed position define an effective surface profile projection wherein said first and second transition openings and thumb and finger openings have an area greater than 30% of the effective surface profile projection of said first handle and said second handle.

19. The scissors of claim 17 wherein said first pair of struts generally diverge at an acute angle from said reduced neck portion.

20. The scissors of claim 16 wherein said second pair of struts generally diverge at an acute angle from said second reduced neck portion.
